(19) United States
(12) Patent Application Publication
(10) Pub. No.: US 2021/0340032 A1
(43) Pub. Date: Nov. 4, 2021

(54) Multi-Stage Ion Separator with Recirculation

(71) Applicants: Massachusetts Institute of Technology, Cambridge, MA (US); Kuwait University, Safat (KW)

(72) Inventors: Bader Shafaqa Al-Anzi, Safat (KW); Sumaya Al-Hammadi, Mubarak Al Kabeer (KW); Junghyo Yoon, Malden, MA (US); Jongyoon Han, Bedford, MA (US)

(21) Appl. No.: 17/325,378

(22) Filed: May 20, 2021

Related U.S. Application Data
(63) Continuation of application No. PCT/US19/63171, filed on Nov. 26, 2019.
(60) Provisional application No. 62/774,009, filed on Nov. 30, 2018.

(51) Int. Cl. C02F 1/469; B01D 61/46; B01D 61/02; B01D 61/58; B01D 61/00; C02F 1/06; C02F 1/44; B01D 3/06

(52) U.S. Cl. CPC C02F 1/4693; B01D 61/46; B01D 61/025; B01D 61/58; B01D 61/002; C02F 1/06; C02F 2301/08; C02F 1/445; B01D 3/06; B01D 2311/25; B01D 2317/02; B01D 2311/2669; C02F 2301/046; C02F 1/441

(57) ABSTRACT

The present invention provides for the use of recirculation loops in single- or multi-stage electrical desalination processes such as Ion Concentration Polarization (ICP) desalination and concentration processes.

### RELATED APPLICATIONS

This application is a continuation of International Application No. PCT/US19/63171, which designated the United States and was filed on Nov. 26, 2019, published in English, which claims the benefit of U.S. Provisional Application No. 62/774,009, filed Nov. 30, 2018. The entire teachings of the above applications are incorporated herein by reference.

### BACKGROUND OF THE INVENTION

Various desalination processes, including reverse osmosis (RO), electrodialysis (ED), ion concentration polarization desalination (ICP) and multi-stage flash distillation (MSF), are used to convert seawater into drinkable water, and reduce the salinity of various wastewater streams for safe-release into the environment. These desalination processes all convert an input stream (feed stream) into two separate output streams (diluate stream and concentrate stream) with decreased and increased salt concentration differences between the two, at the expense of the externally supplied energy.

Ion concentration polarization (ICP) desalination and trifurcate ICP desalination systems have been described, for example, in U.S. Patent App. Pub. No. 2014/0374274 A1 (entitled “Water Desalination/Purification and Bio-Agent Preconcentration by Ion Concentration Polarization”) and U.S. Patent App. Pub. No. 2016/0115045 A1 (entitled “Purification of Ultra-High Saline and Contaminated Water by Multi-Stage Ion Concentration Polarization (ICP) Desalination”). As described in these patent publications, in ICP desalination, both diluate and concentrate streams are separately acquired between two identical ion exchange membranes (IEMs). In contrast, conventional electrodialysis (ED) requires alternating different IEMs, for example, alternating an anion exchange membrane (AEM) and a cation exchange membrane (CEM).

It has been reported that ICP utilizing CEMs can enhance a current utilization (CU) up to 20% compared to electrodialysis under constant current applied, along with other advantages as compared with related electrodialysis techniques (Kim et al. (2016), Scientific Reports 6:31850; doi: 10.1038/srep31850). To improve energy efficiency of ICP, the trifurcate ICP desalination system and method was developed which enables the collection of thin ion depleted and ion enriched layers which develop next to the IEM surface, by dividing outlets of target stream within one channel unit.

Although significant advances have been made in the purification and concentration of feed streams using ICP, there remains a need for improvements in recovery ratio and energy efficiency.

### SUMMARY OF THE INVENTION

The present invention provides for the use of recirculation loops in single- or multi-stage desalination processes, especially electrical desalination processes such as electrodialysis (ED) and Ion Concentration Polarization (ICP). An electrical ion separator allows collection of diluate and concentrate streams when the water stream (or the feed stream), is supplied to the electrical ion separator. The multi-stage electric desalination/concentration is implemented with a serialized connection of one-stage of ion separator, serving as input to the next stage. In multi-stage electric desalination/concentration, a portion of each stream is recirculated to the feed stream of a previous stage (a stage in which the stream has already been circulated).

In certain aspects, the invention is directed to a method of purifying a feed stream containing ionic impurities through a multi-stage ion concentration polarization (ICP) system, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating concentrate outlet that is in fluid communication with an inlet of an upstream stage;
the method comprising the steps of:
a. directing the feed stream into an inlet of the channel of the first stage,
b. applying an electric field across each channel causing formation of an ion depletion zone comprising a diluate stream and formation of an ion enrichment zone comprising a concentrate stream in each channel,
c. directing each diluate stream, other than that of the last stage, to an inlet of the subsequent stage such that the input stream of each of each subsequent stage comprises the diluate output of the previous stage,
d. mixing the concentrate stream from the recirculating concentrate outlet with the input stream of the upstream stage; and
e. collecting the diluate stream from the diluate outlet of the last stage.

The invention also includes a method of concentrating a feed stream containing ionic impurities through a multi-stage ion concentration polarization (ICP) system, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating diluate outlet that is in fluid communication with an inlet of an upstream stage;
the method comprising the steps of:
a. directing the feed stream into an inlet of the channel of the first stage,
b. applying an electric field across each channel causing formation of an ion depletion zone comprising a diluate stream and formation of an ion enrichment zone comprising a concentrate stream in each channel,
c. directing each concentrate stream, other than that of the last stage, to an inlet of the subsequent stage such that the input stream of each of each subsequent stage comprises the concentrate output of the previous stage,
d. mixing the diluate stream from the recirculating diluate outlet with the input stream of the upstream stage; and
e. collecting the concentrate stream from the concentrate outlet of the last stage.

The invention is additionally directed to a multi-stage ion concentration polarization (ICP) system for purifying a feed stream, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating concentrate outlet that is in fluid communication with an upstream inlet; and
wherein each diluate outlet, other than that of the last stage, is in fluid communication with an inlet of the subsequent stage.

In yet additional aspects, the invention is a multi-stage ion concentration polarization (ICP) system for concentrating a feed stream, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating diluate outlet that is in fluid communication with an upstream inlet; and
wherein each concentrate outlet, other than that of the last stage, is in fluid communication with an inlet of the subsequent stage.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic illustration and fluorescent image of ion concentration polarization (ICP) desalination (described, for example, in Kim et al. (2016), Sci Rep 6: 31850).

FIGS. 2A and 2B are schematics showing trifurcated ICP desalination for multi-stage operation (described, for example, in Kim et al. (2017), Desalination 412: 20-31). FIG. 2A shows a schematic view of trifurcated ICP desalination. To obtain thin depletion stream and small amount of dilute flow with high purity, one can trifurcated the main channel into three different output flows in accordance with concentration distribution between membranes. Intermediate stream can be fed to the next stage by batch process or recirculation. FIG. 2B shows a fluorescent image of trifurcated ICP desalination using a feed solution of 0.5 M NaCl. Scale bar indicates 1 mm.

FIG. 3 is an illustration of one-stage electrical ion separator unit.

FIG. 4 is an illustration of the multi (n^{th})-stage unit for desalination.

FIG. 5 is an illustration of the multi (n^{th})-stage unit for concentration.

FIG. 6 is an illustration showing various outlet concentration for reuse applications.

FIG. 7 is a graph showing the total water cost ($/m³) of various outlet concentrations using single stage electrical desalination.

FIG. 8 is a schematic diagram for two-stage electrical desalination.

FIGS. 9A-9F are graphs showing the total water cost using two-stage electrical desalination. Various salt removal ratios (SRR) conditions are applied to achieve diluate concentrations of 7,000 (FIG. 9A), 10,000 (FIG. 9B), 15,000 (FIG. 9C), 20,000 (FIG. 9D), 30,000 (FIG. 9E), and 40,000 ppm (FIG. 9F).

FIG. 10 is a graph showing different combinations of SRR for two ICP treatment stages.

FIG. 11 is a graph showing the optimum total treated water cost using two ICP treatment stages (or two-stage electrical desalination) for different outlet concentrations.

FIG. 12 is a schematic diagram for three-stage electrical desalination.

FIGS. 13A-13F are graphs showing the total water cost using three-stage electrical desalination. Various SRR conditions are applied to achieve diluate concentrations of 7,000 (FIG. 13A), 10,000 (FIG. 13B), 15,000 (FIG. 13C), 20,000 (FIG. 13D), 30,000 (FIG. 13E) and 40,000 ppm (FIG. 13F).

FIG. 14 is a graph showing the optimum treated water cost using three-stage electrical desalination for different outlet concentrations.

FIG. 15 is a graph showing a comparison of Total Treated Water Cost using different ICP treatment stages.

FIG. 16 is a graph showing cost saving by three-stage electrical desalination when the outlet concentration is increased.

FIG. 17 is a schematic illustration of multi-stage electrical desalination with recirculation loops.

FIG. 18 is a schematic illustration of multi-stage electrical concentration with recirculation loops.

FIG. 19 is a schematic illustration of multi-stage electrical ion separator system with recirculation loops with mixing and interconnected point.

FIG. 20 is a schematic illustration of a two-stage electrical ion separator with recirculation loops.

FIG. 21 is a graph showing water cost and recovery rate for recirculation.

### DETAILED DESCRIPTION

A description of preferred embodiments of the invention follows.

As used herein, the words “a” and “an” are meant to include one or more unless otherwise specified.

ICP desalination and trifurcate ICP desalination system have been described, for example, in U.S. Pat. App. Pub. No. 2014/0374274 A1, U.S. Pat. No. 9,845,252, U.S. Pat. App. Pub. No. 20170066665, U.S. Pat. No. 9,850,146, U.S. Pat. App. Pub. No. 2016/0115045 A1 (U.S. patent application Ser. No. 14/920,992, filed Oct. 23, 2015), Kim et al. (2016), Scientific Reports 6:31850; and Kwak et al. (2016), Sci Rep. 6: 25349, the contents of each of which are expressly incorporated by reference herein.

Various desalination processes, including reverse osmosis (RO), electrodialysis (ED), ion concentration polarization desalination (ICP) and multi-stage flash distillation (MSF), are used to convert seawater into drinkable water, and reduce the salinity of various wastewater streams for safe-release into the environment. These processes all convert an input stream (feed stream) into two separate output streams (diluate and concentrate stream) with decreased and increased salt concentration differences between the two, at the expense of the externally supplied energy. From the fundamental point of view, it would seem inadvisable to employ recirculation loops for desalination because any such process would mix already treated diluate or concentrate stream with the feed stream, which would increase the entropy and therefore incur irreversibility (exergy). Therefore, it would seem that the overall desalination process would not benefit from such a recirculation/mixing process since recirculation would represent reversal of the work done by previous desalination processes.

However, it has been appreciated that there are two main reasons why such a recirculation process can enhance the overall desalination efficiency. First, the intended objective of desalination processes (in other words, the desired outcome) may not always be the maximum generation of purified water (diluate stream). Often the overall efficiency of the desalination process is compared and evaluated by the overall treatment cost per output (diluate) volume′ ($/m³). There are many desalination applications where the ultimate goal is the removal of wastewater (salty water), rather than generation of pure water for other uses. One such example is the treatment of wastewater coming out of on-shore/off-shore oil platforms, where highly concentrated brine (produced water) should be treated to minimize the environmental impact caused by the disposal of such wastewater. Second, there are situations where recirculation loops can increase the overall process efficiency, even though some energy may be wasted by the recirculation and mixing. This is because the desalination efficiency of any desalination processes is complex, non-linear function of the feed salinity, flow rates, and many other parameters. Therefore, lost energy by mixing/recirculation could potentially be compensated if the shifted parameter conditions by recirculation could increase the overall energy efficiency of the system more significantly. One example of such scenarios can be found in electrical desalination processes such as ICP or ED, especially for brine (35˜200,000 ppm) treatment/separation. [1] Most ion exchange membranes (IEMs) are designed for medium salinity (brackish water), and the property and selectivity of IEMs, critical for the energy efficiency of ED or ICP, can be adversely affected when the salinity of the intake water is too high. By recirculating some of the output diluate stream and lowering the intake feed, one could recover more energy by increasing the efficiency of ICP or ED processes even if mixing causes some loss of energy as well. There are many situations where recirculation could significantly increase the efficiency of desalination process. Brine partial desalination is one such example that it discussed herein.

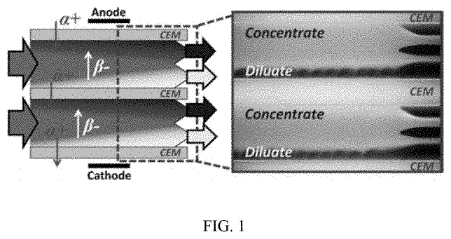

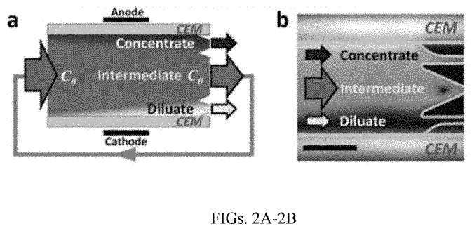

ICP technology follows the same principles as ED except that the alternating ion exchange membranes, located between the two charged anode and cathode electrodes, are of the same kind, for example, they can both be Cation Exchange Membranes (CEMs). Applying DC potential between the two electrodes results in an ion separation due to the movement of charged ions toward opposite electrode charge passing through the cation exchange membrane (CEM) that retains the same charge exchange membrane. This creates two distinct regimes with the concentrated layer closer to the anode electrode. The depleted zone increases gradually along the ICP length. FIG. 1 shows a schematic of an ICP unit of microfluidic size first described in 2016. [2] Since the initial development of ICP, more effort has been invested towards scaling up ICP system for bench scale application. For example, other alternatives to optimize ICP energy performance resulting in a recent trifurcated desalination as described in FIG. 2. In the trifurcate split design of FIG. 2, one can maximize the energy efficiency of the incremental desalination (a related idea to conventional multi-stage desalination process) by sequestering the small part of localized diluate stream, achieving good cost efficiency for brine partial treatment (from 70,000 ppm to 35,000 ppm NaCl). [3] This partial desalination process was recently scaled up to a lab scale prototype device (˜100 mL/min), while maintaining the similar cost efficiency of achieving ˜1$/bbl even though the overall system is only around 30-50 cm long. This demonstrates the merit of ICP desalination process as a promising technology for treating high concentration brine, as an alternative to other techniques such as multi-stage flash distillation (MSF) and mechanical vapor recompression (MVR). The present invention is directed to the use of various recirculation loops which can ultimately increase the efficiency of desalination processes. ICP partial desalination is described herein as an example platform.

As discussed above, electrical desalination systems such as ICP and ED will be affected in a non-linear manner, as the feed salinity is increased beyond seawater (35,000 ppm). There is a general lack of experimental data characterizing membrane performances under such high salinity conditions, at various current/flow conditions. Due to this reason, in order to properly optimize and validate the merits of any recirculation looping in a given ICP (or ED) desalination system, it would be necessary to rely on a simplified model for ICP processes, based on experimental data obtained. Recently, Siwon Choi at MIT carried out such modeling, based on a simplified current model extracted from available experimental data operating ICP desalination processes at various high salinity and flow conditions. Based on this model (with minor modifications), we have evaluated the merits of recirculation loops discussed in more detail below. [4]

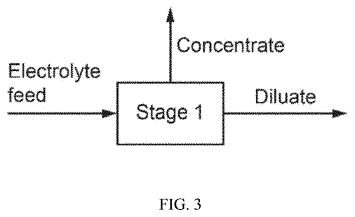

FIG. 3 is a schematic illustration of one-stage electrical ion separator unit, comprising one electrolyte feed input and two outputs, one for the diluate stream and the other for the concentrate stream. The concentrations of the diluate and concentrate streams are determined by their flow and electric conditions. The present invention provides methods for desalination and concentration, including a multi-stage system with serialized implementation of one-stage electrical ion separator. The present invention also provides methods for desalination and concentration, including the multi-stage system with recirculation for improving recovery rate and energy efficiency.

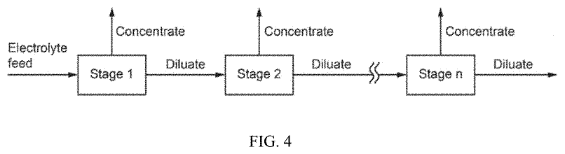

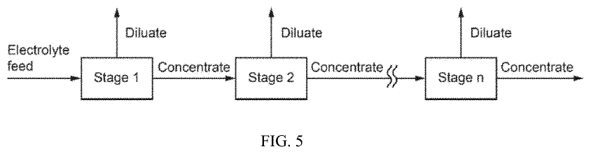

The present invention includes multi-stage electrical desalination and concentration devices and methods. The multi-stage electric ion separator comprises a serialized implementation of one-stage electrical ion separator. Depending on the direction in which the output is connected to the next stage, the multi-stage unit can be used for desalination or concentration. [5] As shown in FIG. 4, all output of diluate streams are connected to each input of the next stage, except the output of the last diluate stream. The configuration of the multi-stage ion separator for concentration is shown in FIG. 5. The outlets of concentration stream are connected to each inlet of the next stage, and then the highly concentration solution flow out at the concentration stream output of last stage.

A simple cost model is employed in order to find a water cost. The water cost includes operating and capital costs. The operating cost is calculated as a sum of pumping and electricity cost. The capital cost includes a total membrane area and annualized factor. The parameter for the water cost calculation is employed from an experimental data, carried by Siwon Choi (MIT), operating ICP desalination processes at various high salinity and flow conditions. [4]

$$Pumping Cost ( \$ \text{/} {m}^{3} ) = \frac{Pumping Power}{Feed Flow rate per Cell} \times {N}_{cell} \times {K}_{E} = \frac{12 μ {Q}_{f} L}{w {d}^{3}} \times \frac{{Q}_{total}}{{Q}_{cell}} \times {K}_{E}$$

$$Electricity Cost ( \$ \text{/} {m}^{3} ) = \frac{I \times V}{{Q}_{R}} \times {K}_{E} = \frac{P}{{Q}_{R}} \times {K}_{E}$$

$$Capital Cost ( \$ \text{/} {m}^{3} ) = \frac{ Used Membrane Cost ( \$ )}{Output Flow Volume per Life ( {m}^{3} )} \times Annualized Factor = \frac{{A}_{m} \times {K}_{Q}}{{Q}_{R} \times T} \frac{{( 1 + r )}^{T} - 1}{T \times r}$$

where P is electrical power consumption (multiplication of current I and voltage V) and Q_{R} is diluate flow rate after recirculation and K_{E} is electicity rate (0.05 $/kWh). μ, L, w and d are dynamic viscosity (kg/m·s), cell length (m), cell width (m), cell depth (m), respectively. Q_{f}, Qₜₒₜₐₗ and Q_{cell} are feed stream, total and cell flow rate, respectively. Aₘ is total membrane area, K_{Q} is capital cost per unit membrane area, r is cost of capital and T is lifetime of equipment.

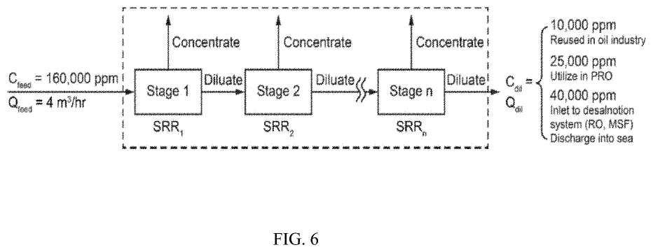

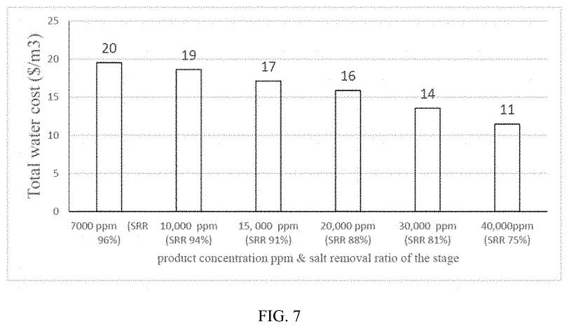

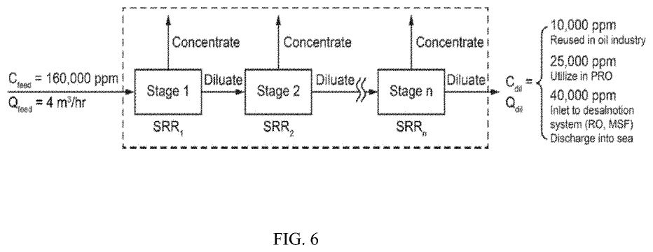

The cost of desalination process plays an important role in the feasibility of using that process. MVR (a forced circulation flash evaporator utilizing mechanical vapor compression) is environmentally preferred for desalinating produced water from oil but it is not economical because of its high overall cost. The higher total cost of MSF including the infrastructure and equipment cost make it economically undesirable. [1] ED is a practically efficient desalination process, providing an economic feasibility. [6], [7] Thus, it is interesting to investigate the cost analysis of multi-stage electrical desalination for treating high saline water. The optimum total treated water cost of treating high salinity feed of 160,000 ppm and the optimum number of stages has been investigated for different outlet concentration to be reutilized for other application as shown in FIG. 6. The final diluate concentrations of 10,000, 25,000 and 40,000 ppm represent typical feed salinities to hydraulic fracturing for oilfield, pressure reverse osmosis (PRO) and reverse osmosis (RO), respectively. [8]-[11]

Table 1 shows the details of operating and capital cost change. It is clear that both operating and capital cost decrease when the dilute concentration increases, although the stage's volumetric flow rate is fixed. This is due to the decrement in the power consumption (since lower SRR is required) which reduces the operating cost. Also, when the power consumption is reduced, the required number of cells is also reduced proving lower capital cost. In other words, lower SRR value can be achieved by the higher velocity (short residence time) which reduces the total membrane area since the outlet flow rate is fixed. For high target SRR, the boundary layer will increase the total resistance which will result in a higher power consumption to achieve the target SRR.

TABLE 1
Total treated water cost of different outlet concentration using one-stage

| Dilute | Dilute | Operating | Capital | Total |
|---|---|---|---|---|
| concentration | concentration | Cost | Cost | Cost |
| (ppm) | (M) | ($/m³) | ($/m³) | ($/m³) |
| 7,000 | 0.12 | 10.91 | 8.63 | 19.54 |
| 10,000 | 0.17 | 10.43 | 8.19 | 18.63 |
| 15,000 | 0.26 | 9.66 | 7.45 | 17.11 |
| 20,000 | 0.34 | 8.73 | 7.15 | 15.88 |
| 30,000 | 0.51 | 7.48 | 6.07 | 13.55 |
| 40,000 | 0.689 | 6.50 | 4.97 | 11.47 |

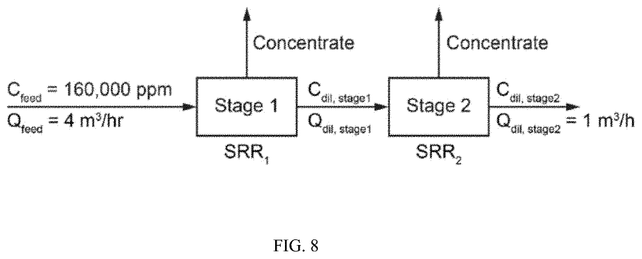

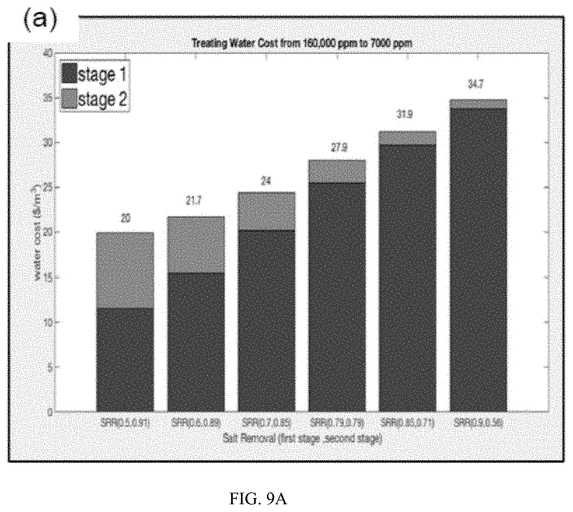

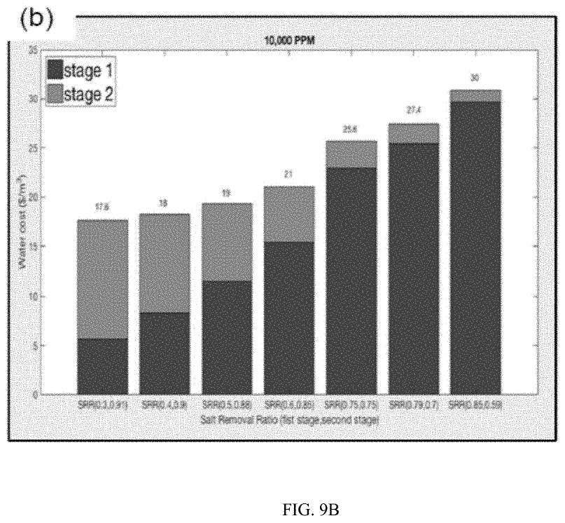

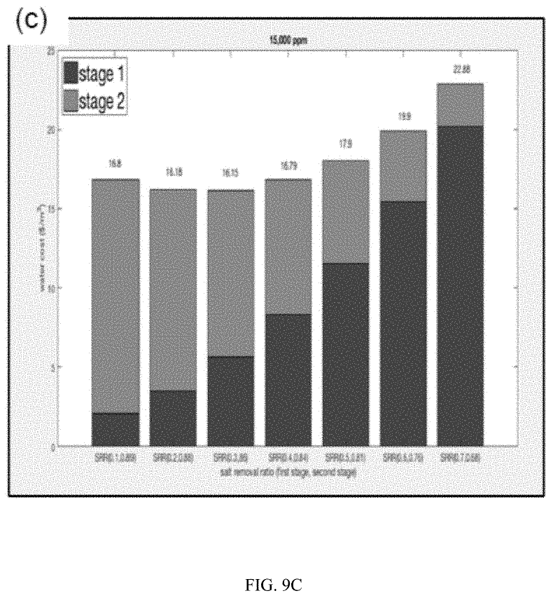

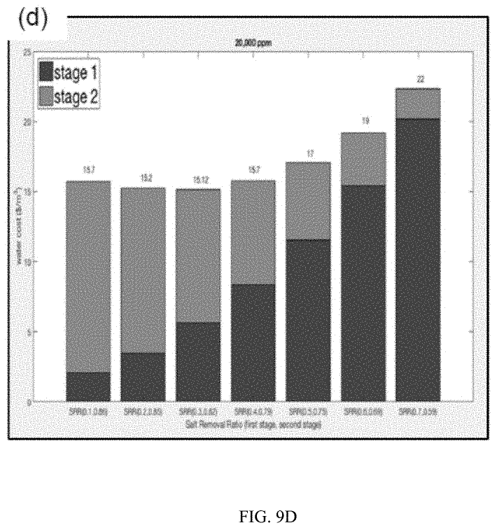

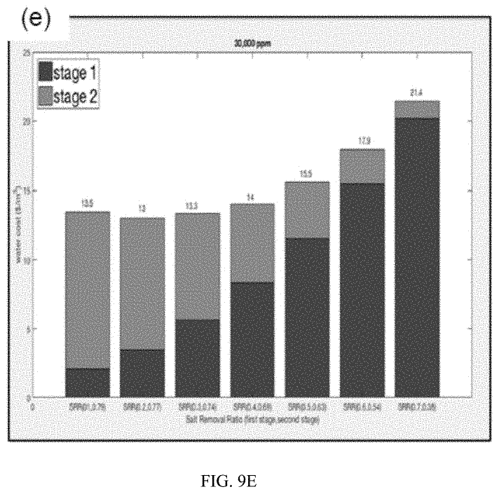

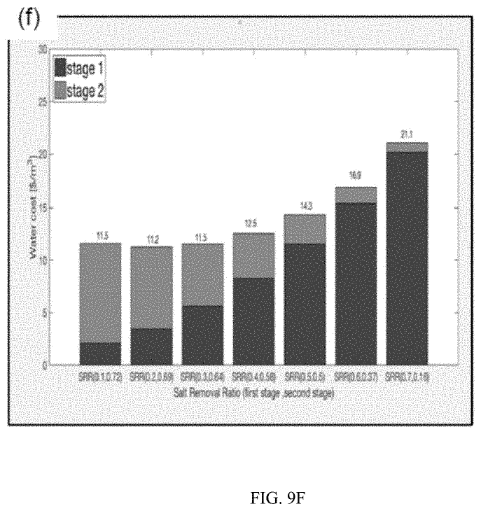

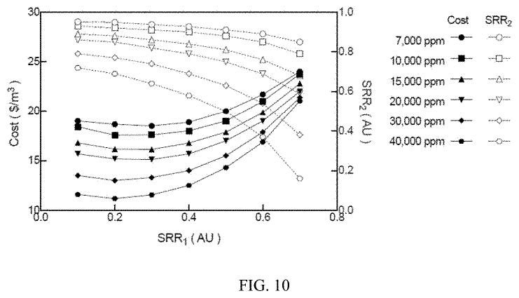

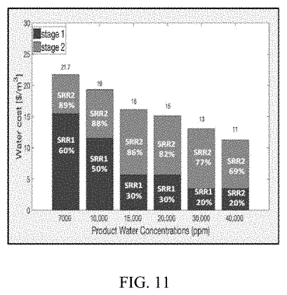

The cost variation by two-stage electrical desalination was evaluated as shown in FIG. 8 (in which smaller driving current and shorter membrane length is used as an important direction for optimization[1]). The new strategy, two-stage electrical desalination, is to consider different combinations of SRR values to achieve a fixed outlet concentration. The variations of water cost are shown in FIG. 9 and FIG. 10. The optimized water costs are plotted in FIG. 11. When the volumetric flow rate of the second stage is lower than the first one by half, we concluded that lower total cost will be achieved when the SRR value in the first stage is lower than the second stage. The total treated water cost has been lowered using this strategy for each outlet concentration.

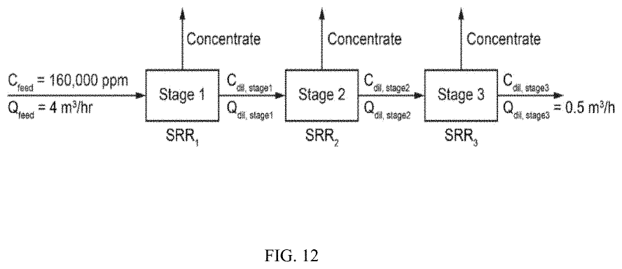

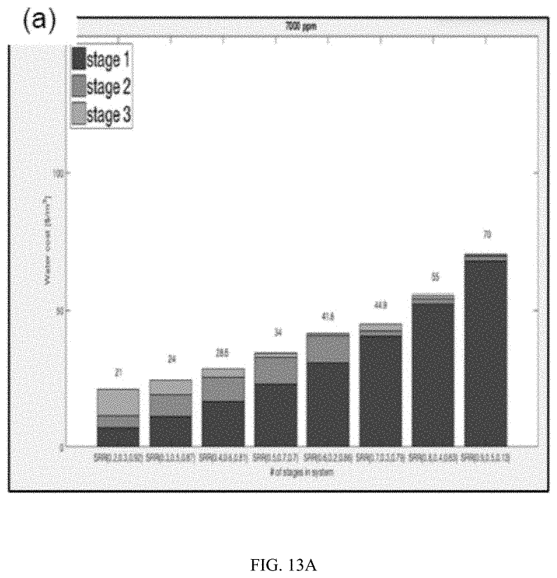

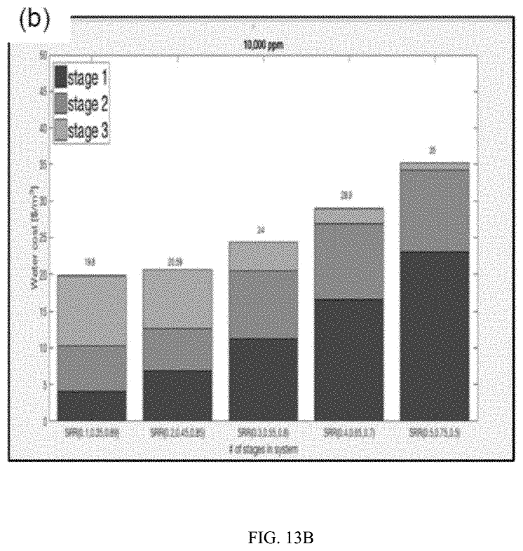

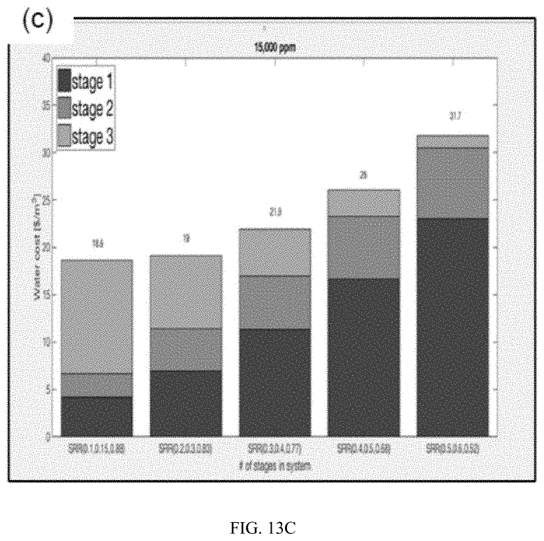

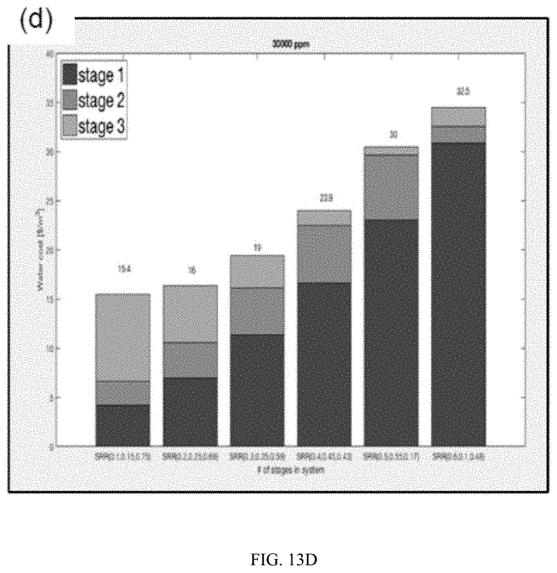

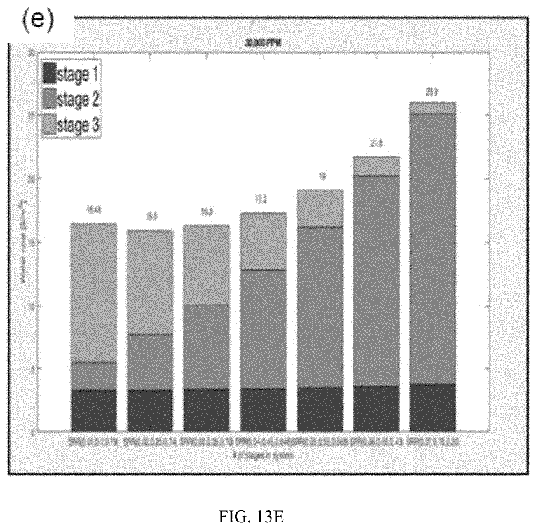

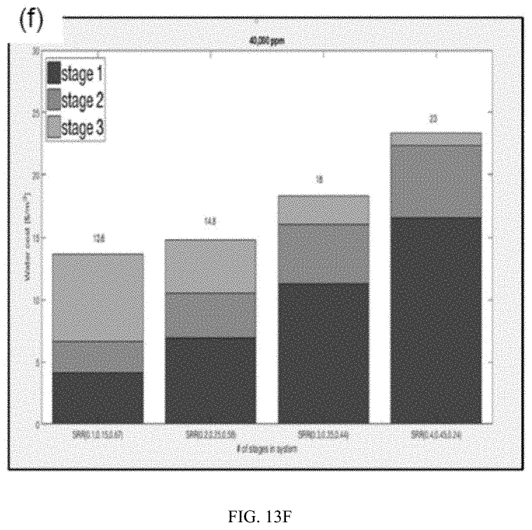

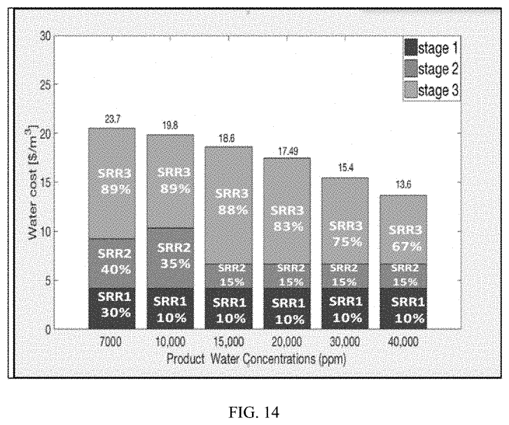

The schematic diagram of three-stage electrical desalination is shown in FIG. 12. The cost to achieve various outlet concentrations has been determined by three-stage electrical desalination in FIG. 13 and FIG. 14. Different combinations of SRR have been used to optimize a water cost. The optimum case for SRRs combination using three-stage electrical desalination is SRR₁<SRR₂<SRR₃.

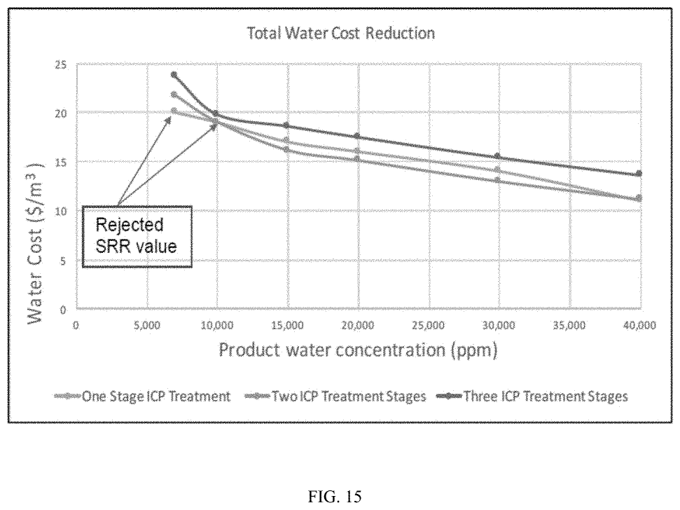

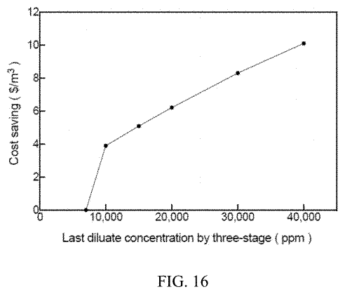

The water cost variations by one, two and three-stage electrical desalination are shown in FIG. 15. It is clear that the cost of two-stage electrical desalination is lower than one or three-stage electrical desalination. From the generated results, the two-stage electrical desalination is the optimum number of stages. Further investigation is needed to find better combinations of SRR for three-stage or n^{th}-stage electrical desalination. It was found that the higher salinity of diluate stream results in lower total water cost and more cost saving as shown in FIG. 16. When the outlet concentration increased, the SRR values in both stages will decrease.

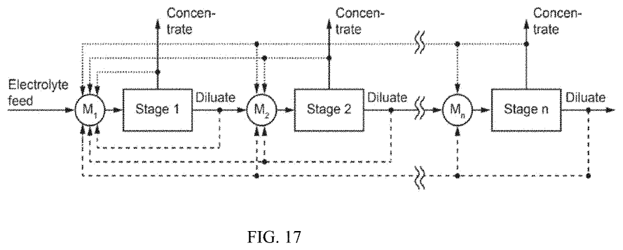

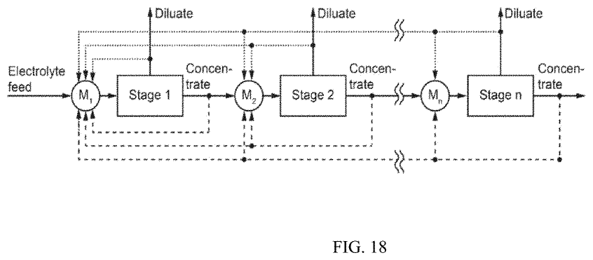

With respect to multi-stage electrical desalination and concentration with a recirculation loop, as the number of stages increases, more desalted and concentrated waters are obtained and instead the recovery rate decreases because one outlet is connected to the next stage, but the other is not connected to the next state and is disposed. It is possible to embed a recirculating operation by connecting one (or more) of disposed outlets to an inlet of an upstream stage placed front as shown in FIGS. 17 and 18. The multi-stage system with recirculation of a disposed stream may be designed and operated for either recirculating diluate and concentrate streams.

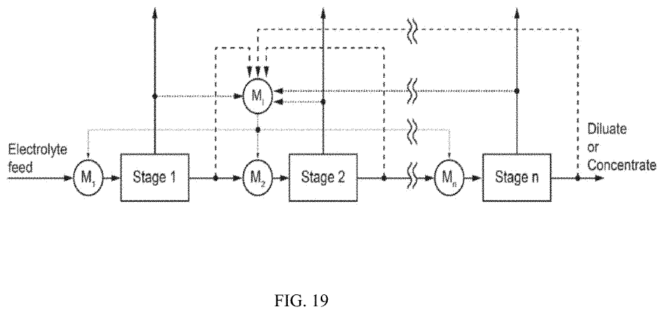

In FIG. 17, the concentrate stream is mixed with the feed stream of an upstream stage placed in front to increase recovery rate and improve energy efficiency. The recovery rate decreases with an increase in stage number without the recirculation, but the recovery rate increases with an increase in recirculation fraction. A certain recirculation stream facilitates a reduction of the concentration of feed stream and the decrease in the feed concentration provides increase in energy efficiency because ion exchange membranes have a higher permselectivity with a low feed salinity. For example, the concentration of the concentrate stream (the n^{th}-stage) is lower than the concentration of feed stream ((n−1)^{th}-stage) at the low salt removal condition. This recirculation scheme is also applicable for the multi-stage electric concentration in FIG. 18. The diluate stream is mixed with the feed stream of a previous stage. The salinity of diluate stream at the n^{th}-stage is higher than the salinity of feed stream at the (n−1)^{th}-stage. This salinity increase in the feed stream provides energy reduction to achieve a certain concentrated brine. Of course, the loops are not limited to the ones shown in FIG. 19 (interconnected loops are also possible). The objective is to find the right loop with the optimum recirculating ratio (R) for each condition that could potentially reduce the total treatment of the system.

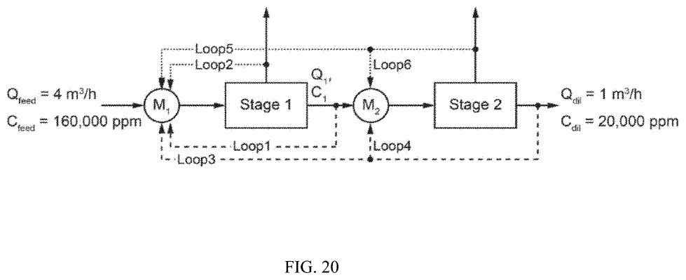

In this embodiment, the two-stage electrical desalination with a recirculation loop is applied to evaluate the overall performance for reducing the water cost. This can be achieved by incorporating multiple recirculation loops that connect each stage together in different ways as shown in FIG. 20. The salinities of feed and diluate stream is fixed as 160,000 and 20,000, respectively. M₁ and M₂ indicate mixing point 1 and 2, respectively. Loop1 connects stage-1 diluate output to M₁. Loop 2 connects stage-1 concentrate to M₁. Loop 3 connects stage-2 diluate output to M₁. Loop 4 connects stage-2 diluate to M₂. Loop 5 connects stage-2 concentrate to M₁. Loop 6 connects stage-2 concentrate output to M₁.

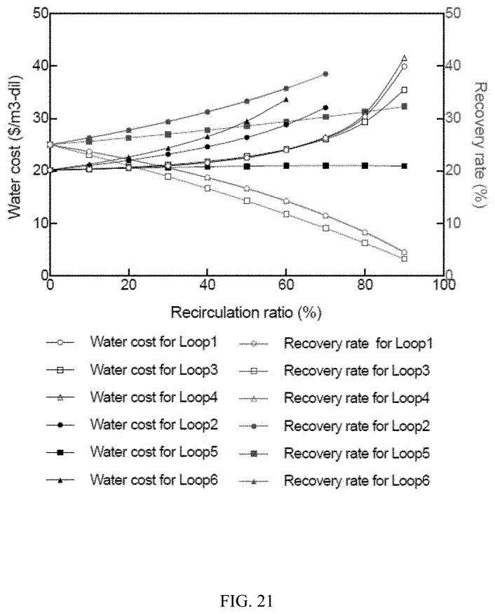

The variation of water cost and its recovery rate are shown in FIG. 21. The detailed data are shown in Table 2. The recirculation of loop 1, 3 and 4 did not provide any advantage for the water cost and recovery rate because recirculation of the diluate stream results in a reduction of feed salinity which can reduce a water cost. In fact, however, the recirculation leads to a redundant process which causes a repeated desalination for the same volume of water with an increase in the entropy of the system. The loops 2, 5 and 6 facilitate a recirculation of concentrated stream which provides increase in recovery rate. The loops 2 and 6 return to the same stage causing increase in feed salinity whereas loop 5 returns to the previous stage providing reduction of feed salinity and water cost.

TABLE 2
The optimized water cost for various recirculation ration with recovery rate and SRR value.

| | Diluate stream recirculation | | | | | | | | | | | |
|---|---|---|---|---|---|---|---|---|---|---|---|---|
| Recirculation | Loop1 | | | | Loop3 | | | | Loop4 | | | |
| fraction | Cost | RR | SRR1 | SRR2 | Cost | RR | SRR1 | SRR2 | Cost | RR | SRR1 | SRR2 |
| (%) | ($/m³) | (%) | (%) | (%) | ($/m³) | (%) | (%) | (%) | ($/m³) | (%) | (%) | (%) |
| 0 | 20.2 | 25.0 | 36.0 | 80.7 | 20.2 | 25.0 | 36.0 | 80.7 | 20.2 | 25.0 | 36.0 | 80.7 |
| 10 | 20.3 | 23.7 | 34.8 | 80.7 | 20.4 | 23.1 | 37.6 | 79.7 | 20.3 | 23.7 | 35.0 | 80.2 |
| 20 | 20.6 | 22.2 | 33.6 | 80.7 | 20.7 | 21.1 | 39.3 | 78.7 | 20.6 | 22.2 | 36.0 | 79.0 |
| 30 | 21.0 | 20.6 | 32.3 | 80.7 | 21.2 | 18.9 | 41.1 | 77.5 | 21.0 | 20.6 | 36.0 | 78.0 |
| 40 | 21.6 | 18.8 | 30.1 | 81.0 | 21.8 | 16.7 | 44.1 | 75.8 | 21.6 | 18.8 | 37.0 | 76.6 |
| 50 | 22.5 | 16.7 | 28.8 | 81.0 | 22.8 | 14.3 | 47.2 | 73.7 | 22.6 | 16.7 | 38.0 | 75.1 |
| 60 | 24.0 | 14.3 | 25.6 | 81.5 | 24.1 | 11.8 | 50.5 | 71.2 | 24.0 | 14.3 | 39.0 | 73.4 |
| 70 | 26.3 | 11.5 | 21.0 | 82.6 | 26.1 | 9.1 | 55.1 | 67.5 | 26.4 | 11.5 | 42.0 | 70.6 |
| 80 | 30.4 | 8.3 | 15.9 | 83.7 | 29.3 | 6.3 | 61.2 | 61.4 | 30.9 | 8.3 | 47.0 | 66.4 |
| 90 | 39.9 | 4.5 | 9.5 | 85.3 | 35.5 | 3.2 | 71.4 | 46.2 | 41.5 | 4.5 | 55.0 | 59.2 |

The optimized water cost for various recirculation ration with recovery rate and SRR value.

| | Concentration stream recirculation | | | | | | | | | | | |
|---|---|---|---|---|---|---|---|---|---|---|---|---|
| Recirculation | Loop2 | | | | Loop5 | | | | Loop6 | | | |
| fraction | Cost | RR | SRR1 | SRR2 | Cost | RR | SRR1 | SRR2 | Cost | RR | SRR1 | SRR2 |
| (%) | ($/m³) | (%) | (%) | (%) | ($/m³) | (%) | (%) | (%) | ($/m³) | (%) | (%) | (%) |
| 0 | 20.2 | 25.0 | 36.0 | 80.7 | 20.2 | 25.0 | 36.0 | 80.7 | 20.2 | 25.0 | 36.0 | 80.7 |
| 10 | 21.0 | 26.3 | 34.2 | 81.5 | 20.4 | 25.6 | 36.2 | 80.7 | 21.3 | 26.3 | 37.0 | 81.2 |
| 20 | 22.0 | 27.8 | 33.6 | 82.1 | 20.5 | 26.3 | 37.4 | 80.4 | 22.7 | 27.8 | 40.0 | 81.3 |
| 30 | 23.2 | 29.4 | 32.1 | 82.8 | 20.7 | 27.0 | 38.5 | 80.1 | 24.4 | 29.4 | 42.0 | 81.8 |
| 40 | 24.6 | 31.3 | 30.8 | 83.5 | 20.8 | 27.8 | 39.6 | 79.7 | 26.6 | 31.3 | 45.0 | 82.1 |
| 50 | 26.4 | 33.3 | 29.7 | 84.1 | 20.9 | 28.6 | 40.6 | 79.4 | 29.5 | 33.3 | 49.0 | 82.4 |
| 60 | 28.8 | 35.7 | 27.8 | 84.9 | 21.0 | 29.4 | 42.3 | 78.7 | 33.6 | 35.7 | 54.0 | 82.6 |
| 70 | 32.1 | 38.5 | 26.1 | 85.6 | 21.0 | 30.3 | 43.2 | 78.3 | | | | |
| 80 | | | | | 21.0 | 31.3 | 44.7 | 77.5 | | | | |
| 90 | | | | | 20.9 | 32.3 | 46.2 | 76.7 | | | | |

As described above, the systems and methods described herein include multi-stage electrical desalination systems, preferably ICP systems, comprising one or more recirculation loops. The system can comprise any number (n) of stages. In certain aspects, the system comprises two stages. In yet additional aspects, the system comprises at least three stages, at least four stages, or at least five stages.

The invention includes a method of purifying a feed stream containing ionic impurities through a multi-stage electrical ion separator system, wherein the system comprises a plurality of stages fluidly connected in series, each stage comprising a channel, and wherein the plurality of stages comprises a first stage, a last stage, and optionally one or more stages between the first and last stages,
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating concentrate outlet that is in fluid communication with an inlet of an upstream stage;
the method comprising the steps of:
   a. directing the feed stream into an inlet of the channel of the first stage,
   b. applying an electric field across each channel causing formation of a diluate stream and formation of a concentrate stream in each channel,
   c. directing each diluate stream, other than that of the last stage, to an inlet of the subsequent stage such that the input stream of each of each subsequent stage comprises the diluate output of the previous stage,
   d. mixing the concentrate stream from the recirculating concentrate outlet with the input stream of the upstream stage; and
   e. collecting the diluate stream from the diluate outlet of the last stage.

The invention also includes a method of concentrating a feed stream containing ionic impurities through an electrical ion separator system, wherein the system comprises a plurality of stages fluidly connected in series, each stage comprising a channel, and wherein the plurality of stages comprises a first stage, a last stage, and optionally one or more stages between the first and last stages,
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating diluate outlet that is in fluid communication with an inlet of an upstream stage;
the method comprising the steps of:
   a. directing the feed stream into an inlet of the channel of the first stage,
   b. applying an electric field across each channel causing formation of a diluate stream and formation of a concentrate stream in each channel,
   c. directing each concentrate stream, other than that of the last stage, to an inlet of the subsequent stage such that the input stream of each of each subsequent stage comprises the concentrate output of the previous stage,
   d. mixing the diluate stream from the recirculating diluate outlet with the input stream of the upstream stage; and
   e. collecting the concentrate stream from the concentrate outlet of the last stage.

The electrical ion separator system can, for example, be an electrodialysis system or an ICP system.

For ICP systems, each stage comprises a channel wherein each channel is defined, at least in part, by a first ion exchange membrane and a second ion exchange membrane, wherein the ion exchange membranes are juxtaposed and characterized by the same charge. When used for purifying a feed stream, the diluate output of each stage (except for that of the last stage) is directed to the subsequent stage such that the input stream of each subsequent stage comprises the diluate output of the previous stage. When concentrating a feed stream, the concentrate output of each stage (except for that of the last stage) is directed to the subsequent stage such that the input stream of each of each subsequent stage comprises the concentrate output of the previous stage.

Each channel further comprises an inlet, a diluate outlet, and a concentrate outlet, wherein the diluate stream is directed to the diluate outlet and the concentrate stream is directed to the concentrate outlet. A recirculating concentrate outlet is a concentrate outlet that is in fluid communication with the inlet of an upstream stage such that the stream of the recirculating outlet is recirculated through the upstream stage (for example, after mixing with the other input). A recirculating diluate outlet is a diluate outlet that is in fluid communication with the inlet of an upstream stage such that the stream of the recirculating outlet is recirculated through the upstream stage (after mixing with the other input). Recirculating outlets can also be referred herein to as “recirculating loops.”

Such non-limiting examples of recirculating loops are illustrated in FIGS. 17, 18, and 19. When purifying the feed stream, the recirculating loop can recirculate the concentrate stream of the recirculating outlet through a channel in which it has already circulated. When concentrating the feed stream, the recirculating loop can recirculate a diluate stream through a channel in which it has already circulated. Specific recirculating concentrate loops (recirculating concentrate outlets) are shown, for example, in FIG. 17, as the dotted lines (labeled “Concentrate”) going from stage 1, stage 2, or stage n to M₁, M₂ or Mₙ (mixing points in fluid communication with the inlets of stage 1, stage 2 and stage n). Specific recirculating diluate loops (recirculating diluate outlets) are also shown, for example, in FIG. 18, as the dotted lines (labeled “Diluate”) going from stage 1, stage 2, or stage n to M₁, M₂ or Mₙ (mixing points in fluid communication with the inlets of stage 1, stage 2 and stage n). In some examples, the stream of the recirculating outlet can mix with the input stream of the upstream stage to form a mixed stream which is directed to the channel of the upstream stage. The mixing of the stream from the recirculating outlet and the input of the upstream stage can occur at different points, for example, at a point upstream of the inlet, at the inlet, or in the channel itself. As described in more detail below, the term “upstream” in this context is relative to the recirculating outlet thus, the upstream stage can be the same stage as that of the recirculating outlet or an earlier stage in the series.

The “first stage” is the first stage in the series into which the feed stream is directed. The “last stage” is the last stage in the series from which the diluate or concentrate is collected.

As used herein, an “upstream stage” refers to a stage that has an inlet that is upstream of the recirculating concentrate outlet. For example, when the last stage comprises a recirculating outlet and the recirculating outlet is in fluid communication with the inlet of an upstream stage, this upstream stage can be the last stage itself, the first stage, and/or a stage between the first and last stage in the series. It is to be understood that an upstream stage can be the same stage as that of the recirculating concentrate outlet. For example, when the recirculating concentrate outlet is the concentrate outlet of the first stage, the stream from the recirculating outlet can be in fluid communication with the inlet of the first stage and mixes with the feed stream (the input of the inlet of the first stage). The “input stream of the upstream stage” is the feed stream (for the first stage) or the output of the previous stage (for stages other than the first stage). The “mixed” stream is the input stream of the upstream stage mixed with the stream from the recirculating concentrate outlet. For example, if the concentrate outlet of stage 1 of FIG. 17 is a recirculating outlet then the stream of the stage 1 concentrate outlet is mixed with the feed stream and the mixed stream is circulated in stage 1.

The multi-stage systems and methods comprise directing each diluate/concentrate stream (other than that of the last stage) to the inlet of the subsequent stage. In this context, the “subsequent stage” refers to the next stage in the series, for example, the diluate/concentrate stream from the first outlet is directed to the second stage, and the diluate/concentrate generated in the second stage is directed to the third stage in the series, and so on. Also, as described herein, the input stream of each subsequent stage comprises the diluate/concentrate stream of the previous outlet. In the context, the “previous outlet” refers to the prior outlet in the series, for example, the input stream of the second stage comprises the diluate/concentrate stream generated in the first stage, and the input stream of the third stage comprises the diluate/concentrate stream generated in the second stage, and so on.

The multi-stage systems and methods include at least one stage which has a recirculating concentrate outlet. As described above, a recirculating concentrate outlet is a concentrate outlet that is in fluid communication with the inlet of an upstream stage. The systems and methods can be used for desalinating and/or purifying a feed stream (such as a water stream) comprising:
a. directing the feed stream into an inlet of the channel of the first stage,
b. applying an electric field across each channel causing formation of an ion depletion zone comprising a diluate stream and formation of an ion enrichment zone comprising a concentrate stream in each channel,
c. directing each diluate stream, other than that of the last stage, to an inlet of the subsequent stage such that the input stream of each of each subsequent stage comprises the diluate output of the previous stage,
d. mixing the concentrate stream from the recirculating concentrate outlet with the input of the upstream stage; and
e. collecting the diluate stream from the diluate outlet of the last stage.

As described above, multiple configurations of the device/system and the recirculating loop(s) are possible. For example, in some examples, the concentrate streams from the concentrate outlets other than that of the recirculating concentrate outlet are disposed of. In certain additional examples, the system has only one recirculating concentrate outlet and in other examples, the system has more than one recirculating concentrate outlet, for example, two, three, four, or more. In some examples, a recirculating concentrate outlet is in fluid communication with the inlet of the first stage and the stream of the recirculating concentrate outlet mixes with the feed stream. In additional examples, a recirculating concentrate outlet is the concentrate outlet of the last stage and the stream of the recirculating concentrate outlet mixes with the input stream of the last stage (the diluate stream from the previous stage). In yet other examples, the system includes a recirculating concentrate outlet that is the concentrate outlet of a stage between the first and last stages. In yet other aspects, all of the concentrate outlets of the system are recirculating concentrate outlets.

The system can also be configured to concentrate a feed stream (such as a water stream). Such a system can be used to concentrate a feed stream comprising the steps of:
a. directing the feed stream into an inlet of the channel of the first stage,
b. applying an electric field across each channel causing formation of an ion depletion zone comprising a diluate stream and formation of an ion enrichment zone comprising a concentrate stream in each channel,
c. directing each concentrate stream, other than that of the last stage, to an inlet of the subsequent stage such that the input stream of each of each subsequent stage comprises the concentrate output of the previous stage,
d. mixing the diluate stream from the recirculating diluate outlet with the input of the upstream stage; and
e. collecting the concentrate stream from the concentrate outlet of the last stage.

As described above, multiple configurations of the device/system and the recirculating loop(s) are possible. For example, in some examples, the diluate streams from the diluate outlets other than that of the recirculating concentrate outlet are disposed of. In certain additional examples, the system has only one recirculating diluate outlet and in other examples, the system has more than one recirculating diluate outlet, for example, two, three, four, or more. In some examples, a recirculating diluate outlet is in fluid communication with the inlet of the first stage and the stream of the recirculating diluate outlet mixes with the feed stream. In additional examples, a recirculating diluate outlet is the diluate outlet of the last stage and the stream of the recirculating diluate outlet mixes with the input stream of the last stage (in other words, the concentrate stream from the previous stage). In yet other examples, the system includes a recirculating diluate outlet that is the diluate outlet of a stage between the first and last stages. In yet other aspects, all of the diluate outlets of the system are recirculating diluate outlets.

In certain additional aspects, the systems and methods described herein can also be single stage comprising a recirculation loop as described herein. For example, the invention includes a method of purifying a feed stream containing ionic impurities through a single-stage ion concentration polarization (ICP) system, wherein the single stage comprises a channel,
wherein the channel is defined, at least in part, by a first ion exchange membrane and a second ion exchange membrane, wherein the ion exchange membranes are juxtaposed and characterized by the same charge;
wherein the channel further comprises an inlet, a diluate outlet, and a recirculating concentrate outlet, wherein the diluate stream is directed to the diluate outlet and at least a portion of the concentrate stream is directed to the recirculating concentrate outlet;
wherein the recirculating concentrate outlet is in fluid communication with the inlet;
the method comprising the steps of:
   a. directing the feed stream into an inlet of the channel of the single stage,
   b. applying an electric field across the channel causing formation of an ion depletion zone comprising a diluate stream and formation of an ion enrichment zone comprising a concentrate stream in each channel,
   c. mixing the concentrate stream from the recirculating concentrate outlet with the feed stream; and
   d. collecting the diluate stream from the diluate outlet of the last stage.

The diluate concentration the diluate stream from the last stage can, for example, be between about 500 to 40,000 ppm, or between 10,000 to 40,000 ppm.

The invention also encompasses a method of concentrating a feed stream containing ionic impurities through a single-stage ion concentration polarization (ICP) system, wherein the single stage comprises a channel,
wherein the channel is defined, at least in part, by a first ion exchange membrane and a second ion exchange membrane, wherein the ion exchange membranes are juxtaposed and characterized by the same charge;
wherein the channel further comprises an inlet, a concentrate outlet, and a recirculating diluate outlet, wherein the concentrate stream is directed to the concentrate outlet, and at least a portion of the diluate stream is directed to the recirculating diluate outlet;
wherein the recirculating diluate outlet is in fluid communication with the inlet;
the method comprising the steps of:
a. directing the feed stream into an inlet of the channel of the single stage,
b. applying an electric field across each channel causing formation of an ion depletion zone comprising a diluate stream and formation of an ion enrichment zone comprising a concentrate stream in each channel,
c. mixing the diluate stream from the recirculating diluate outlet with the feed stream; and
d. collecting the concentrate stream from the concentrate outlet of the last stage.

In certain aspects of the multi-stage and single-stage methods, the stream is further desalinated/concentrated using a method selected from the group consisting of reverse osmosis (RO), pressure retarded osmosis (PRO), and multi-stage flash distillation (MSF).

As discussed above, ICP desalination/concentration utilizes ICP between two identical IEMs. Between two juxtaposed similar ion exchange membranes (AEMs or CEMs), an ion depletion zone and ion enrichment zone are generated under an electric field. As cations are selectively transferred through the CEMs, for example, anions are relocated in order to achieve electro-neutrality, resulting in the concentration drop (increase) in the ion depletion (enrichment) zone.

The systems and methods described herein produce at least two streams: a stream which has reduced ionic species and a stream which concentrated ionic species. The stream which has reduced ionic species can be referred to as the “dilute stream,” the “diluate stream,” the “purified water stream” or the “diluate,” interchangeably herein unless otherwise indicated. The stream which has concentrated ionic species can be referred to as the “concentrate stream,” or the “concentrated ion aqueous stream,” or the “concentrate” interchangeably herein unless otherwise indicated.

The ion exchange membranes can be cation exchange membranes (CEMs) or anion exchange membranes (AEMs). In certain preferred embodiments, the ion exchange membranes are CEMs. The electric field can be created by an electrode and a ground each located external and parallel to the channels. The two ion exchange membranes can be the same or different. Strong anion or cation exchange membranes, as those products are generally sold in the art, are preferred. FUMASEP® FTAM-E and FTCM-E (FuMA-Tech CmbH, Germany) are suitable membranes. A suitable membrane is also a NAFION® membrane, for example, a NAFION® perfluorinated membrane available, for example, from Sigma Aldrich, USA. However, others can also be used. In particular, the term “ion exchange membrane” is intended to include not only porous, microporous, and/or nanoporous films and membranes, but also resins or materials through which ions can pass. Thus, in one embodiment, an ion exchange resin can be entrapped by one or more meshes (or porous membranes) in lieu of or in addition to one or more of the ion exchange membranes. In certain aspects, the ion exchange membranes comprise micrometer sized pores (or micro pores). In yet additional aspects, the ion exchange membranes comprise nanometer sized pores (or nano pores). In yet further aspects, the ion exchange membranes comprise micro pores and nano pores. An exemplary ion exchange membrane comprising micro pores and nano pores has been described, for example, in Kwon et al., (2015), A Water Permeable Ion Exchange Membrane for Desalination, 19th International Conference on Miniaturized Systems for Chemistry and Life Sciences October 25-29, Gyeongju, Korea available at http://www.rsc.org/images/LOC/2015/PDFs/Papers/1202 T.302e.pdf, the contents of which are expressly incorporated by reference herein. The ion exchange membranes can be placed into a support, such as glass, polydimethylsiloxane or other inert material. Thus, the support can also contribute to the formation of the channels.

In certain aspects, a channel is formed by cation exchange membranes (CEMs). Anion exchange membranes (AEMs) can also be used in the desalination/concentration methods described herein.

The channels described herein include at least two outlets, one outlet is for the purified water stream (the diluate outlet) and the other outlet is for the concentrate.

The feed stream is directed into the channel via the inlet. For purification, the diluate stream generated in the first stage is directed to the second stage and the concentrate stream is discarded or recirculated depending on the configuration of the system. For concentration, the concentrate stream generated in the first stage is directed to the second stage and the diluate stream is discarded or recirculated depending on the configuration of the system. For multi-stage ICP systems, these steps repeat until the last stage.

In general, the channel formed by the two juxtaposed ion exchange membranes does not contain a membrane carrying a charge counter to the two juxtaposed ion exchange membranes. The consequence of the configuration is that only positive (or negative) ions, but not both participate in conduction. In other words, the ions in the electrolyte solution or aqueous stream to be purified that participate in the conduction in the apparatus, or cell, carry a common charge, while the counterions or ions carrying the opposite charge, while present, do not participate in conduction. Thus, the invention preferably excludes the use of an apparatus that traditionally functions via electrodialysis.

The electric field can be generated by an electrode and a ground each located external and parallel to the channel. The electric field can be generated, for example, by an anode and a cathode. An electrode can form another channel (e.g., a second channel) with the first ion exchange membrane, for example, an anode can form a second channel with the first ion exchange membrane. The ground, or for example the cathode, can form yet another channel (e.g., a third channel) with the second ion exchange membrane. The second and third channels can be filled with an electrolyte solution. In certain aspects, the electrolyte solution is the first water stream.

In certain additional embodiments, the first water stream comprises a salt. The first water stream can, for example, be water with a range of salinities, for example, brackish water, seawater, produced water, seawater, and brine. The terms “brackish water,” “produced water,” and “brine” are terms known to those of skill in the art. In certain aspects, brackish water can refer to water having a salinity less than about 10,000 ppm and/or having an NaCl concentration greater than about 0.5M NaCl. In certain aspects, produced water can have a salinity greater than about 30,000 ppm. In certain aspects, brine can refer to water with higher salinity than 35,000 ppm TDS and/or water having an NaCl concentration greater than about 1M NaCl. In certain aspects, the first water stream can be wastewater, for example, brackish groundwater, household water rich in bacteria or other biological contaminants, or simply murky water from various suspended solids and/or industrial heavy metal contaminants.

Salt removal ratio is a parameter to indicate the desalting ability of devices. By measuring the concentration (or conductivity) of sample flows Co and that of the desalted flow Cdesafted, we can figure out how many salt ions are removed from the discrepancy between the two conductivities. Salt removal ratio is non-dimensional form of the amount of desalted ions by the initial ion concentration (or conductivity):

$$Salt removal ratio = \frac{{C}_{0} - {C}_{desalted}}{{C}_{0}} .$$

### REFERENCES

[1] B. Kim, R. Kwak, H. J. Kwon, Van Sang Pham, M. Kim, B. Al-Anzi, G. Lim, and J. Han, “Purification of High Salinity Brine by Multi-Stage Ion Concentration Polarization Desalination,” Sci Rep, vol. 6, p. 31850, August 2016.
[2] R. Kwak, V. S. Pham, B. Kim, L. Chen, and J. Han, “Enhanced Salt Removal by Unipolar Ion Conduction in Ion Concentration Polarization Desalination,” Sci Rep, vol. 6, p. 25349, May 2016.
[3] B. Kim, H. Kwon, S. H. Ko, G. Lim, and J. Han, “Partial desalination of hypersaline brine by lab-scale ion concentration polarization device,” Desalination, vol. 412, pp. 20-31, June 2017.
[4] S. Choi, “Microfluidic engineering of water purification,” Massachusetts Institute of Technology, 2017.
[5] B. Kim, J. Han, and R. Kwak, “Purification of ultra-high saline and contaminated water by multi-stage ion concentration polarization (ICP) desalination,” US 2016/0115045 A1, 28 Apr. 2016.
[6] H.-J. Lee, F. Sarfert, H. Strathmann, and S.-H. Moon, “Designing of an electrodialysis desalination plant,” Desalination, vol. 142, no. 3, pp. 267-286, March 2002.
[7] G. Belfort, Synthetic Membrane Process. Elsevier, 2012.
[8] D. L. Shaffer, L. H. Arias Chavez, M. Ben-Sasson, S. Romero-Vargas Castrillón, N. Y. Yip, and M. Elimelech, “Desalination and Reuse of High-Salinity Shale Gas Produced Water: Drivers, Technologies, and Future Directions,” Environ Sci Technol, vol. 47, no. 17, pp. 9569-9583, August 2013.
[9] F. Y. C. Huang, A. D. Martinez, and Q. Wei, “Beneficial Use of Highly Saline Produced Water in Pressure-Retarded Osmosis,” Environmental Engineering Science, vol. 35, no. 5, pp. 472-483, May 2018.
[10] V. Piemonte, M. Prisciandaro, L. Di Paola, and D. Barba, Membrane processes for the treatment of produced waters, vol. 43. 2015, pp. 2299-2304.
[11] L. Shafer, “Water Recycling and Purification in the Pinedale Anticline Field: Results From the Anticline Disposal Project,” presented at the SPE Americas E&P Health, Safety, Security, and Environmental Conference, 2011.

While this invention has been particularly shown and described with references to preferred embodiments thereof, it will be understood by those skilled in the art that various changes in form and details may be made therein without departing from the scope of the invention encompassed by the appended claims.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications and references cited herein are incorporated by reference in their entirety.

1. A method of purifying a feed stream containing ionic impurities through a multi-stage ion concentration polarization (ICP) system, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one concentrate outlet is a recirculating concentrate outlet that is in fluid communication with the inlet of an upstream stage;
the method comprising the steps of:
a. directing the feed stream into an inlet of the channel of the first stage,
b. applying an electric field across each channel causing formation of an ion depletion zone comprising a diluate stream and formation of an ion enrichment zone comprising a concentrate stream in each channel,
c. directing each diluate stream, other than that of the last stage, to an inlet of the subsequent stage such that the input stream of each subsequent stage comprises the diluate output of the previous stage,
d. mixing the concentrate stream of the recirculating concentrate outlet with the input stream of the upstream stage; and
e. collecting the diluate stream from the diluate outlet of the last stage.

2. The method of claim 1, wherein the multi-stage ICP system has two stages.

3. The method of claim 1, wherein the multi-stage ICP system has at least three stages.

4. The method of claim 3, wherein the multi-stage ICP system has at least four stages.

5. The method of claim 1, wherein concentrate streams from the concentrate outlets other than the recirculating concentrate outlet are disposed of.

6. The method of claim 1, wherein at least one recirculating concentrate outlet is in fluid communication with the inlet of the first stage and wherein the stream of the recirculating concentrate outlet mixes with the feed stream.

7. The method of claim 1, wherein the system has only one recirculating concentrate outlet.

8. The method of claim 1, wherein at least one recirculating concentrate outlet is the concentrate outlet of the last stage.

9. The method of claim 1, wherein at least one recirculating concentrate outlet is the concentrate outlet of a stage between the first and last stages.

10. The method of claim 1, wherein all of the concentrate outlets are recirculating concentrate outlets.

11. The method of claim 1, wherein the ion exchange membranes are anion exchange membranes.

12. The method of claim 1, wherein the ion exchange membranes are cation exchange membranes.

13. (canceled)

14. The method of claim 1 wherein the feed stream comprises salt.

15. The method of claim 14, wherein the feed stream is brine.

16. The method of claim 15, wherein the brine is high concentration brine.

17. The method of claim 14, wherein the feed stream is selected from the group consisting of brackish water, produced water, and seawater.

18. (canceled)

19. (canceled)

20. The method of claim 1, wherein the diluate concentration of the diluate stream from the last stage is between about 500 to 40,000 ppm.

21. (canceled)

22. The method of claim 1, wherein the diluate stream from the last stage is further desalinated using a method selected from reverse osmosis (RO), pressure retarded osmosis (PRO), and multi-stage flash distillation (MSF).

23. The method of claim 1, wherein the method is partial desalination of high concentration brine.

24. A method of concentrating a feed stream containing ionic impurities through a multi-stage ion concentration polarization (ICP) system, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating diluate outlet that is in fluid communication with an inlet of an upstream stage;
the method comprising the steps of:
a. directing the feed stream into an inlet of the channel of the first stage,
b. applying an electric field across each channel causing formation of an ion depletion zone comprising a diluate stream and formation of an ion enrichment zone comprising a concentrate stream in each channel,
c. directing each concentrate stream, other than that of the last stage, to an inlet of the subsequent stage such that the input stream of each of each subsequent stage comprises the concentrate output of the previous stage,
d. mixing the diluate stream of the recirculating diluate outlet with the input of the upstream stage; and
e. collecting the concentrate stream from the concentrate outlet of the last stage.

25-42. (canceled)

43. A multi-stage ion concentration polarization (ICP) system for purifying a feed stream, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating concentrate outlet that is in fluid communication with an inlet of an upstream stage; and
wherein each diluate outlet, other than that of the last stage, is in fluid communication with an inlet of the subsequent stage.

44. A multi-stage ion concentration polarization (ICP) system for concentrating a feed stream, wherein the system comprises a plurality of ICP stages fluidly connected in series, each stage comprising a channel, and wherein the plurality of stages comprises a first stage, a last stage, and optionally one or more stages between the first and last stages,
wherein each channel is defined, at least in part, by a first ion exchange membrane and a second ion exchange membrane, wherein the ion exchange membranes are juxtaposed and characterized by the same charge;
wherein each channel further comprises an inlet, a diluate outlet, and a concentrate outlet, wherein the diluate stream is directed to the diluate outlet and the concentrate stream is directed to the concentrate outlet;
wherein at least one stage comprises a recirculating diluate outlet that is in fluid communication with an inlet of an upstream stage; and
wherein each concentrate outlet, other than that of the last stage, is in fluid communication with an inlet of the subsequent stage.
